(19) United States
(12) Patent Application Publication
(10) Pub. No.: US 2015/0296350 A1
(43) Pub. Date: Oct. 15, 2015

(54) LONG TERM EVOLUTION NETWORK SYSTEM FOR GROUP COMMUNICATION

(71) Applicant: Institute For Information Industry, Taipei (TW)

(72) Inventors: Jian-Ya CHU, Taichung City (TW); Yi-Hsueh TSAI, New Taipei City (TW); Hsuan-Li LIN, Taipei City (TW)

(21) Appl. No.: 14/685,844

(22) Filed: Apr. 14, 2015

Related U.S. Application Data
(60) Provisional application No. 61/979,500, filed on Apr. 14, 2014.

(51) Int. Cl. H04W 4/08; H04W 72/00; H04L 29/06; H04W 12/04; H04W 12/10

(52) U.S. Cl. CPC H04W 4/08; H04W 12/04; H04W 12/10; H04L 63/0435; H04W 72/005

(57) ABSTRACT

A long term evolution network system and a group communication method thereof. The long term evolution network system includes a base station and a user equipment. The base station stores a communication group list. The user equipment listens to the base station according to a pre-authorized setting. The base station broadcasts the communication group list and the user equipment receives the communication group list. The user equipment selects a communication group from the communication group list according to the pre-authorized setting.

### PRIORITY

This application claims priority to U.S. Provisional Patent Application No. 61/979,500 filed on Apr. 14, 2014, which is hereby incorporated by reference in its entirety.

### FIELD

The present invention relates to a Long Term Evolution (LTE) network system for group communication; and more particularly, in the LTE network system according to the present invention, a user equipment (UE) can directly listen to information of a base station according to a pre-authorized setting and the group communication is dominated by the base station.

### BACKGROUND

In the conventional LTE network, communication between individual UEs can be accomplished not only via a base station and a backhaul network, but can also be accomplished by dividing the UEs into groups through a grouping mechanism and then accomplishing common communications between a plurality of UEs by virtue of characteristics of the groups.

In detail, grouping in the conventional LTE network must be accomplished in the following way: firstly the UEs are registered with the backhaul network via the base station (e.g., an eNodeB), and after information of the UEs is transmitted to a group communication system enabler server of the backhaul network by the base station, the group communication system enabler server can register the UEs accordingly and accomplish communication grouping of the UEs.

Then, when group communication is to be performed by the UEs, the UEs can transmit the communication data to the group communication system enabler server via the base station, and the communication data is transmitted by the group communication system enabler server to a communication group to which the UEs belongs to complete the group communication.

However, in the grouping mechanism of the conventional LTE network, the group registration and group communication of UEs are both accomplished by the group communication system enabler server of the backhaul network. Thus, transmission of the communication messages in such a long network route will cause a network delay, and moreover, communication abnormalities of the base station and the backhaul network will cause a failure in communication of the UEs in the group.

Further, the UEs cannot be registered with the group communication system enabler server via the base station in case of an asymmetric connection status between the UEs and the base station. In this case, it is impossible for the UEs to join in a related group to listen to the group communication. In other words, it is impossible for the UEs to listen to the group communication under radio silence conditions.

Accordingly, efforts have to be made in the art to improve the communication grouping mechanism of the LTE network so that the network delay of data transmissions can be effectively solved to increase the utilization efficiency of network resources and group communications can be effectively maintained.

### SUMMARY

Disclosed is a group communication method for use in a Long Term Evolution (LTE) network system. The LTE network system comprises a base station and a user equipment (UE). The base station stores a communication group list. The group communication method comprises: (a) enabling the UE to listen to the base station according to a pre-authorized setting; (b) enabling the base station to broadcast the communication group list after the step (a); (c) enabling the UE to receive the communication group list; and (d) enabling the UE to select a communication group from the communication group list according to the pre-authorized setting.

Further disclosed is an LTE network system, which comprises a base station and a UE. The base station stores a communication group list. The UE is configured to listen to the base station according to a pre-authorized setting. The base station is configured to broadcast the communication group list. The UE is further configured to: receive the communication group list; and select a communication group from the communication group list according to the pre-authorized setting.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an LTE network system according to a first embodiment of the present invention;

FIG. 1B is a block diagram of a base station according to the first embodiment of the present invention;

FIG. 1C is a block diagram of a first UE according to the first embodiment of the present invention;

FIG. 2 is a schematic view of an LTE network system according to a second embodiment of the present invention;

FIG. 3A is a schematic view of an LTE network system according to a third embodiment of the present invention;

FIG. 3B is a block diagram of a base station according to the third embodiment of the present invention;

FIG. 4A is a schematic view of an LTE network system according to a fourth embodiment of the present invention;

FIG. 4B is a block diagram of a base station according to the fourth embodiment of the present invention;

FIG. 5 is a schematic view of an LTE network system according to a fifth embodiment of the present invention;

FIG. 6 is a flowchart diagram of a group communication method according to a sixth embodiment of the present invention;

FIG. 7 is a flowchart diagram of a group communication method according to a seventh embodiment of the present invention;

FIG. 8 is a flowchart diagram of a group communication method according to an eighth embodiment of the present invention;

FIG. 9 is a flowchart diagram of a group communication method according to a ninth embodiment of the present invention;

FIG. 10 is a flowchart diagram of a group communication method according to a tenth embodiment of the present invention; and

FIG. 11 is a flowchart diagram of a group communication method according to an eleventh embodiment of the present invention.

### DETAILED DESCRIPTION

In the following description, the present invention will be explained with reference to example embodiments thereof. It shall be appreciated that, these example embodiments are not intended to limit the present invention to any specific examples, embodiments, environment, applications or particular implementations described in these embodiments. Therefore, description of these example embodiments is only for purpose of illustration rather than to limit the present invention, and the scope of this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

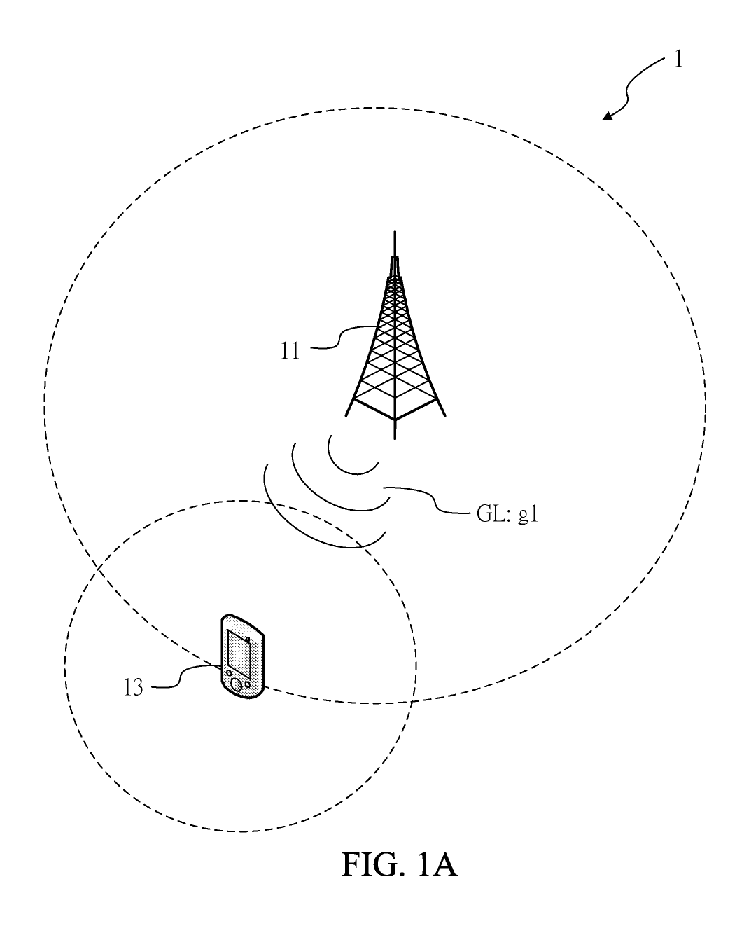

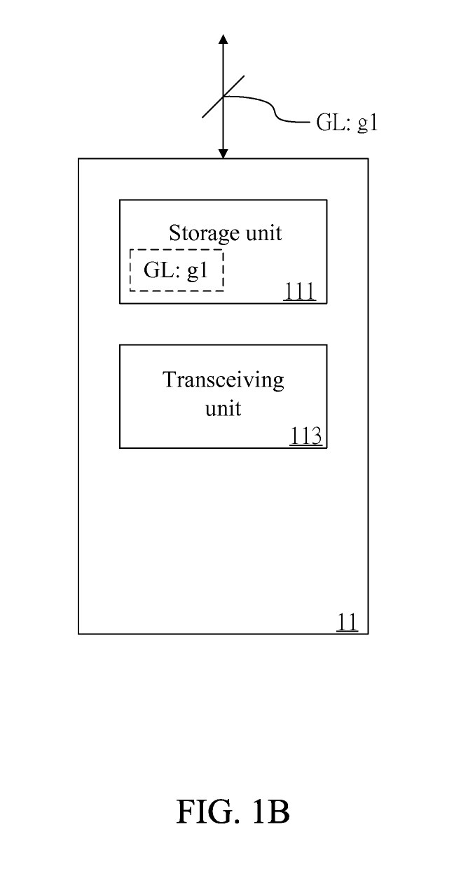

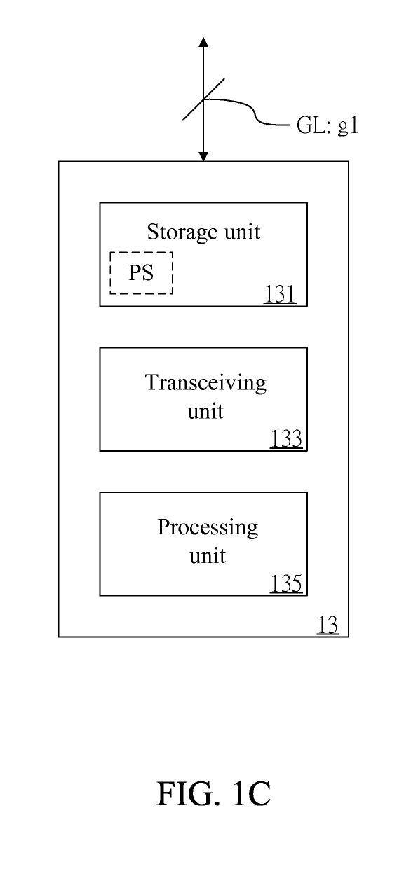

Please refer to FIGS. 1A-1C. FIG. 1A is a schematic view of an LTE network system 1 according to a first embodiment of the present invention. The LTE network system 1 comprises a base station 11 and a first UE 13. FIG. 1B is a block diagram of the base station 11 according to the first embodiment of the present invention. The base station 11 comprises a storage unit 111 and a transceiving unit 113, and the storage unit 111 stores a communication group list GL. FIG. 1C is a block diagram of the first UE 13 according to the first embodiment of the present invention. The first UE 13 comprises a storage unit 131, a transceiving unit 133 and a processing unit 135. Interactions among the individual elements will be further described hereinbelow.

Firstly, the storage unit 131 of the first UE 13 stores a pre-authorized setting PS. The pre-authorized setting PS mainly comprises legally authorized information that permits the first UE 13 to join in a communication group of the corresponding LTE network system 1. Accordingly, the transceiving unit 133 of the first UE 13 can directly listen to messages sent by the base station 11 according to the pre-authorized setting PS.

Next, when the transceiving unit 113 of the base station 11 broadcasts the communication group list GL, the transceiving unit 133 of the first UE 13 can receive the communication group list GL. Furthermore, because the pre-authorized setting PS may further comprise information indicating the group in which the first UE 13 is to join, the processing unit 135 of the first UE 13 can select a communication group g1, in which the first UE 13 is to perform group communication, from the communication group list GL according to the pre-authorized setting PS.

In this way, if it is impossible to transmit messages to the base station 11 due to an asymmetric communication status between the first UE 13 and the base station 11, the first UE 13 still can use the pre-authorized setting PS to obtain a related authorized setting of group communication and directly listen to the group messages broadcasted by the base station 11 according to the related authorized setting of group communication. It shall be particularly appreciated that, even if a symmetric communication status exists between the first UE 13 and the base station 11, the first UE 13 still can use the pre-authorized setting PS to listen to the group messages broadcasted by the base station 11 so that the group messages can be obtained quickly without the need of uploading data.

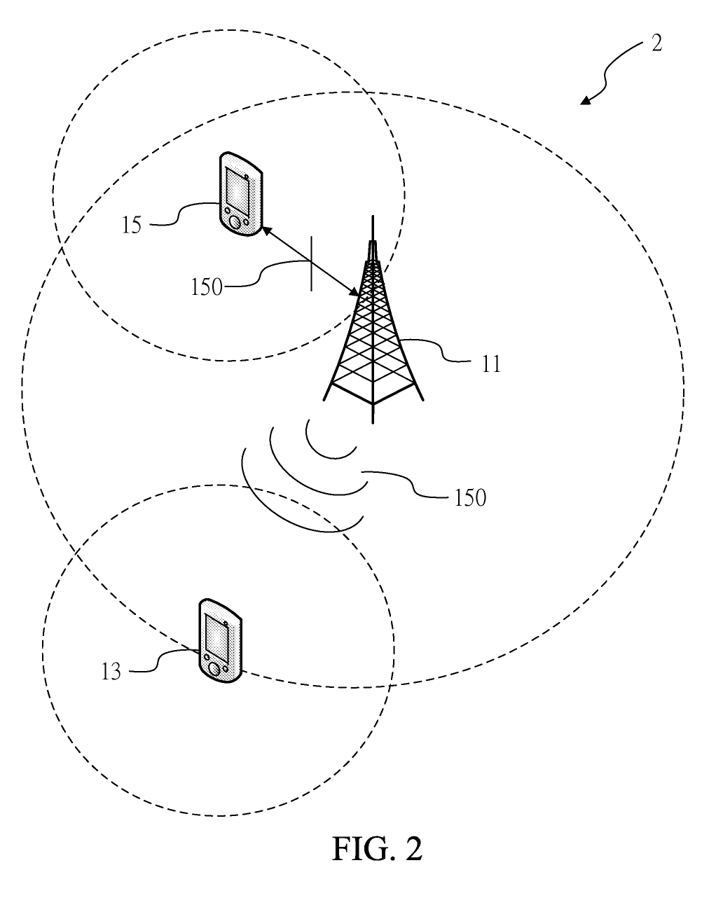

Please refer to FIG. 2, which is a schematic view of an LTE network system 2 according to a second embodiment of the present invention. The architecture of the second embodiment is similar to that of the first embodiment, so elements bearing the same reference numerals also have the same functions and, thus, will not be further described herein. However, the second embodiment is mainly used to describe how the first UE 13 receives the communication group message of the communication group g1 broadcasted by the base station 11 after the first UE 13 has selected the communication group g1.

Specifically, the LTE network system 2 further comprises a second UE 15 which also belongs to the communication group g1. Thus, when desiring to send a group message in the communication group g1, the second UE 15 directly transmits a communication group message 150 to the base station 11.

Then, after having received the communication group message 150, the transceiving unit 113 of the base station 11 can directly broadcast the communication group message 150 in the communication group g1. Accordingly, because the first UE 13 has selected the communication group g1 as the group for listening to messages, the communication group message 150 broadcasted by the base station 11 still can be received by the transceiving unit 133 of the first UE 13 to accomplish the group communication even if an asymmetric network status exists between the first UE 13 and the base station 11.

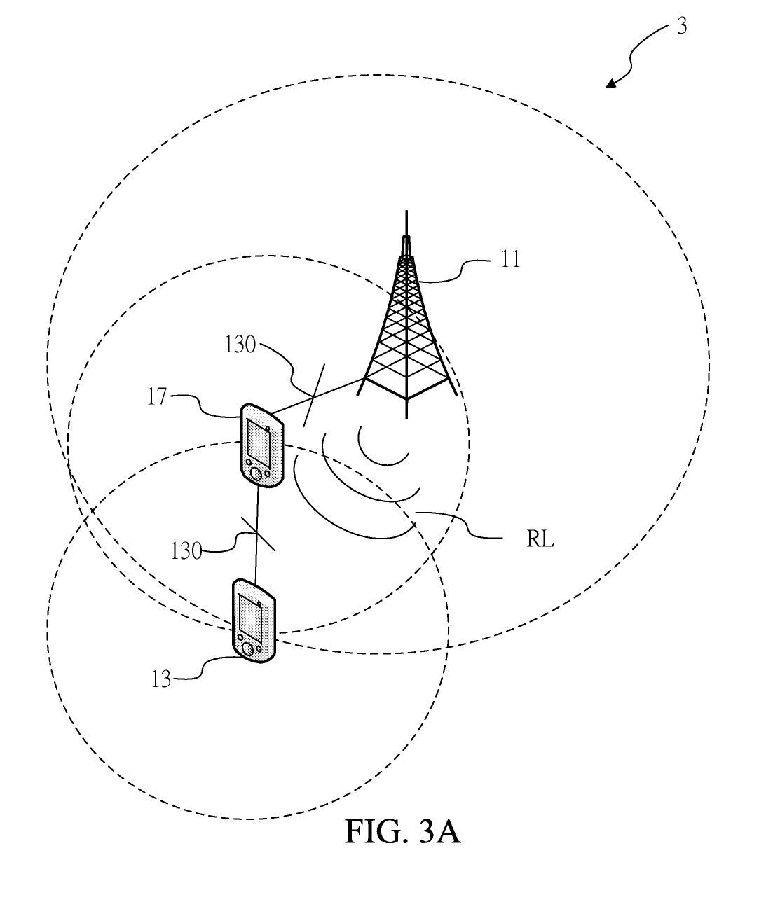

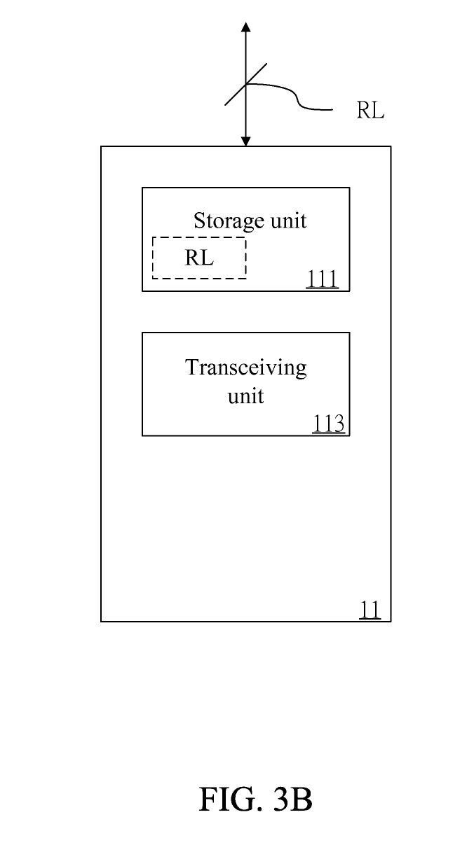

Please refer to FIG. 3A, which is a schematic view of an LTE network system 3 according to a third embodiment of the present invention. The architecture of the third embodiment is similar to that of the first embodiment, so elements bearing the same reference numerals also have the same functions and, thus, will not be further described herein. However, the third embodiment is mainly used to describe how the first UE 13 sends group messages in the communication group g1 when an asymmetric communication status exists between the first UE 13 and the base station 11.

Please refer to FIG. 3B together, which is a block diagram of the base station 11 according to the third embodiment of the present invention. The storage unit 111 further stores a relay point list RL, and the relay point list RL is mainly used to record UEs or base stations that can act as relay points. Then, the transceiving unit 113 of the base station 11 broadcasts the relay point list RL, and the relay point list RL is received by the transceiving unit 133 of the first UE 13.

Afterwards, the processing unit 135 of the first UE 13 may select a relay point 17 available for communication nearby the first UE 13 from the relay points recorded in the relay point list RL. Then, the transceiving unit 133 of the first UE 13 transmits a communication group message 130 to the base station 11 via the relay point 17 available for communication. Accordingly, the transceiving unit 113 of the base station 11 can broadcast the communication group message 130 in the communication group g1 so that the message of the first UE 13 can be received by other UEs in the communication group g1.

It shall be particularly appreciated that, considering the security of group message transmission, the message transmission process in the previous embodiments may be accomplished in an encrypted manner. For example, the pre-authorized setting PS stored in the first UE 13 may further comprise a key (not depicted), and this key is mainly used for message encrypting communication with the base station.

Further speaking, the communication group list GL, the relay point list RL and the communication group message 150 of the previous embodiments all may be encrypted data. Therefore, after the transceiving unit 133 has received the communication group list GL, the relay point list RL and the communication group message 150, the processing unit 135 of the first UE 13 may use the key in the pre-authorized setting PS to decrypt the communication group list GL, the relay point list RL and the communication group message 150 so as to obtain contents thereof.

On the other hand, the first UE 13 may also first encrypt the group message that is to be sent. In detail, in the previous embodiments, the communication group message 130 may be encrypted by the processing unit 135 in advance through the use of the key before being transmitted by the first UE 13, and then the encrypted communication group message 130 is transmitted to the base station 11 by the transceiving unit 133 via a relay point.

In this way, the security of the pre-authorized group communication can also be guaranteed through the use of the key. It shall be additionally emphasized that, how to apply the technology of encrypting and decrypting messages to the aforesaid message transmission of group communication of the present invention so as to guarantee the communication security shall be readily understood by people of ordinary skill in the art, so the operation process of encrypting and decrypting messages will not be further described herein.

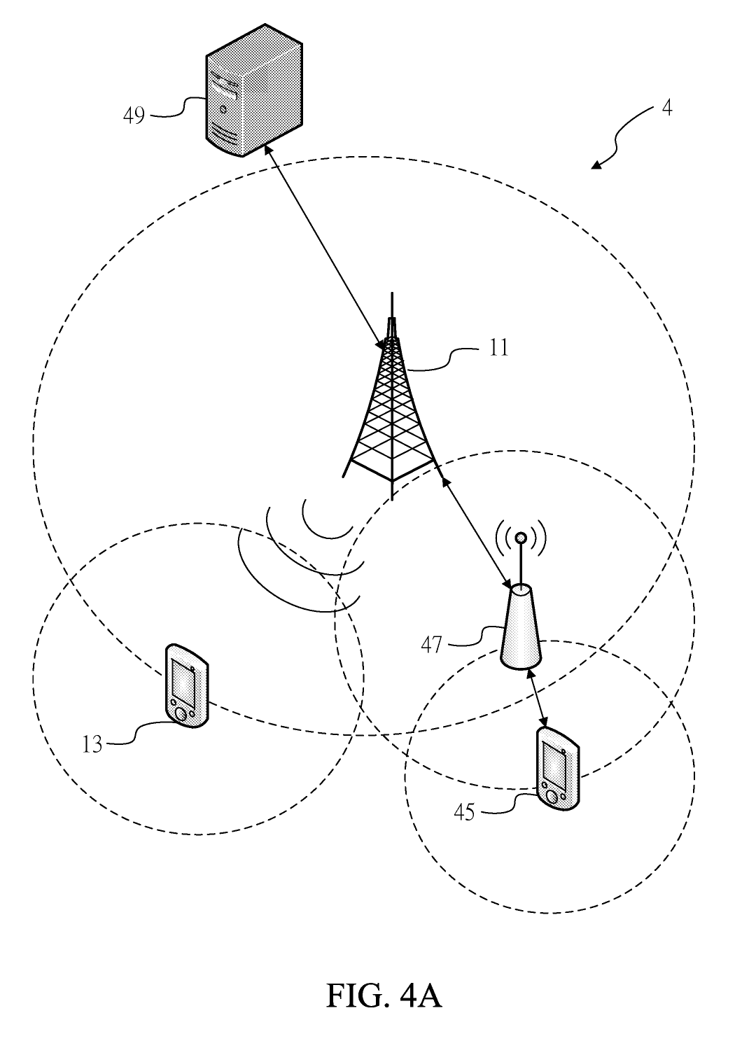

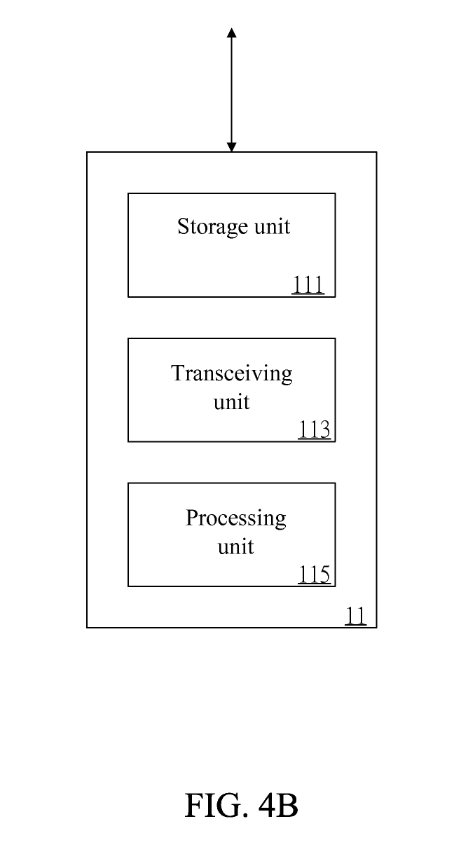

Please refer to FIG. 4A, which is a schematic view of an LTE network system 4 according to a fourth embodiment of the present invention. The architecture of the fourth embodiment is similar to those of the previous embodiments, so elements bearing the same reference numerals also have the same functions and, thus, will not be further described herein. It shall be particularly appreciated that, the base station 11 further connects to a backhaul network 49 in the fourth embodiment; however, the backhaul network 49 here is only used to process control signals of UEs but not to process group messages. The fourth embodiment is mainly used to describe how the base station 11 operates after a connection with the backhaul network is disconnected.

Likewise, as described in the first embodiment, the processing unit 135 of the first UE 13 selects the communication group g1 in which the first UE 13 is to perform group communication from the communication group list GL according to the pre-authorized setting PS. On the other hand, the transceiving unit 113 of the base station 11 further connects to a second UE 45 via a relay node 47. The second UE 45 also belongs to the communication group g1.

Please refer to FIG. 4B together, which is a block diagram of a base station 11 according to the fourth embodiment of the present invention. The base station 11 further comprises a processing unit 115. The group communication between the first UE 13 and the second UE 45 is mainly in the charge of the base station 11, so when the processing unit 115 of the base station 11 determines via the transceiving unit 113 that the connection between the base station 11 and the backhaul network 49 is disconnected, the processing unit 115 of the base station 11 can directly maintain the group communication between the first UE 13 and the second UE 45 via the transceiving unit 113.

It shall be particularly appreciated that, in the fourth embodiment, the first UE 13 may also send the group message to the base station 11 via a relay node as described in the third embodiment, and this will not be further described herein.

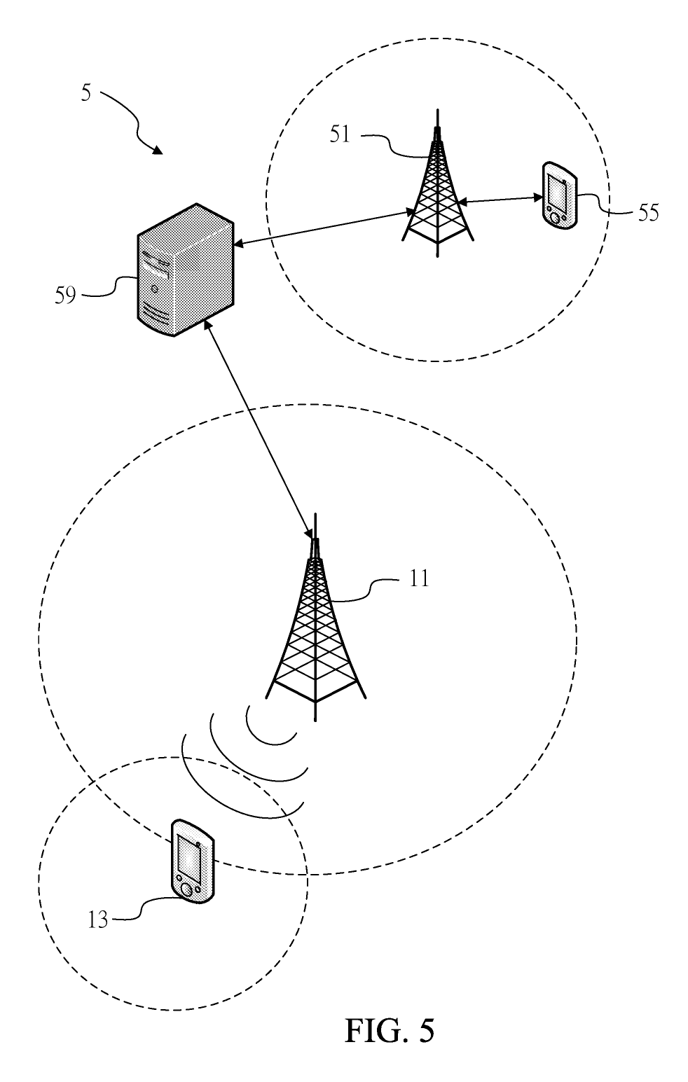

Please refer to FIG. 5, which is a schematic view of an LTE network system 5 according to a fifth embodiment of the present invention. The architecture of the fifth embodiment is similar to those of the previous embodiments, so elements bearing the same reference numerals also have the same functions and, thus, will not be further described herein. It shall be particularly appreciated that, the base station 11 further connects to a second UE 55 via a backhaul network 59 and a base station 51 in the fifth embodiment. Likewise, the backhaul network 59 is only used to process control signals of UEs but not to process group messages. The fifth embodiment is mainly used to describe how the base station 11 adjusts the communication according to the network status of the backhaul network 59.

Likewise, as described in the first embodiment, the processing unit 135 of the first UE 13 selects the communication group g1 in which the first UE 13 is to perform group communication from the communication group list GL according to the pre-authorized setting PS. On the other hand, the transceiving unit 113 of the base station 11 further directly connects to the backhaul network 59, and connects to the second UE 55 via the base station 51. The second UE 55 also belongs to the communication group g1.

Then when a network status (not depicted) of the LTE network system 5 changes (e.g., in case of network overload, degradation in connection quality or the like), the processing unit 115 of the base station 11 may accordingly adjust the Quality of Service (QoS) between the first UE 13 and the second UE 55 via the transceiving unit 113 to guarantee that normal group communication is maintained between the first UE 13 and the second UE 55. Likewise, in the fifth embodiment, the first UE 13 may also send the group message to the base station 11 via a relay node as described in the third embodiment, and this will not be further detailed herein.

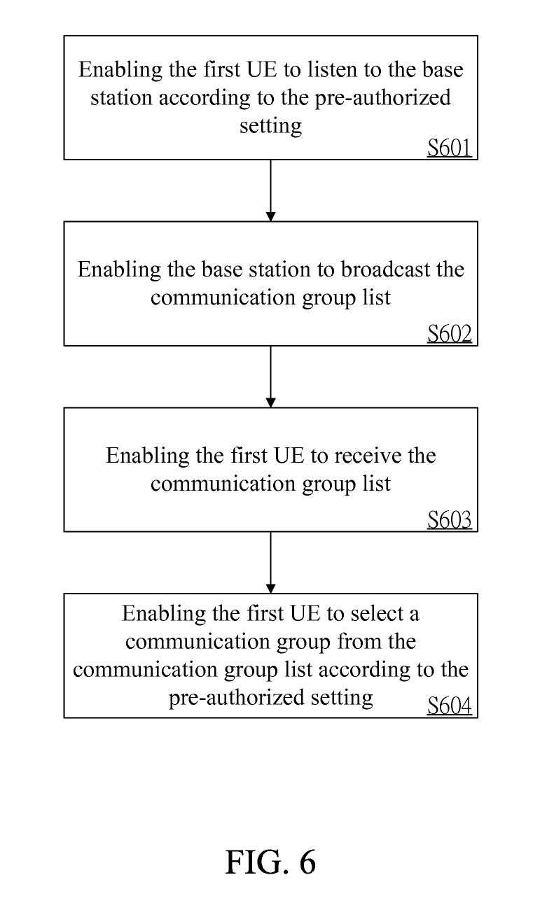

A sixth embodiment of the present invention is a group communication method, a flowchart diagram of which is shown in FIG. 6. The method of the sixth embodiment is for use in an LTE network system (e.g., the LTE network system of the previous embodiments). The LTE network system comprises a base station and a first UE. The base station stores a communication group list, and the first UE stores a pre-authorized setting. Detailed steps of the sixth embodiment are described as follows.

Firstly, because the pre-authorized setting comprises legally authorized information that permits the first UE to join in a communication group of the corresponding LTE network system, step S601 is executed to enable the first UE to listen to the base station according to the pre-authorized setting. Step S602 is executed to enable the base station to broadcast the communication group list.

Then, step S603 is executed to enable the first UE to receive the communication group list. Finally, because the pre-authorized setting may further comprise information indicating the group in which the first UE is to join, step S604 is executed to enable the first UE to select a communication group from the communication group list according to the pre-authorized setting. Thereby, the first UE can use the pre-authorized setting to listen to the group message broadcasted by the base station no matter in a symmetric communication status or in an asymmetric communication status.

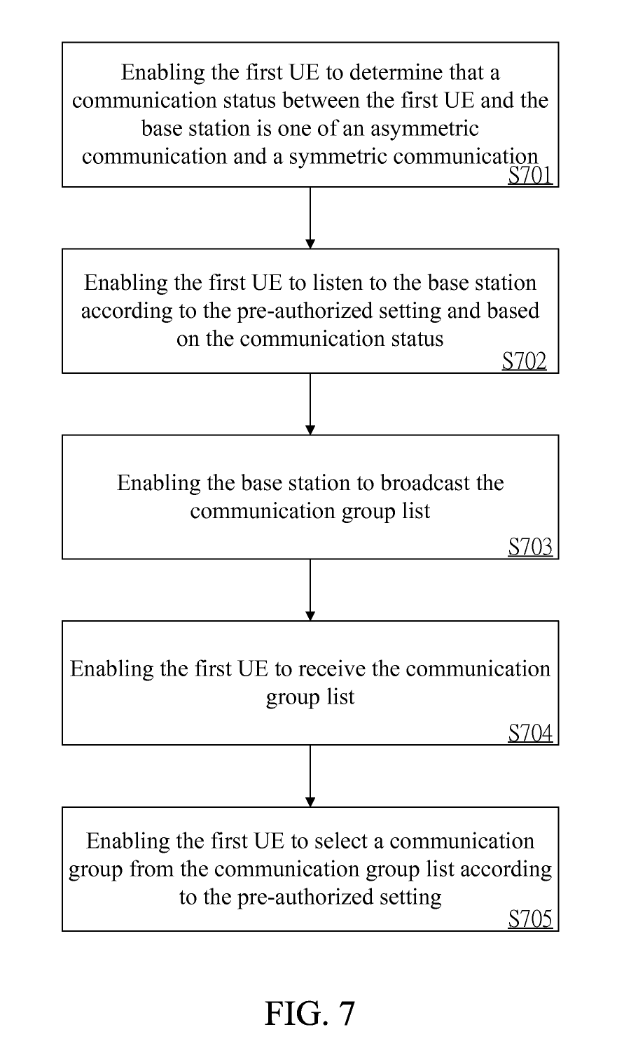

A seventh embodiment of the present invention is a group communication method, a flowchart diagram of which is shown in FIG. 7. The method of the seventh embodiment is for use in an LTE network system (e.g., the LTE network system of the previous embodiments). The LTE network system comprises a base station and a first UE. The base station stores a communication group list, and the first UE stores a pre-authorized setting. Detailed steps of the seventh embodiment are described as follows.

Firstly, step S701 is executed to enable the first UE to determine that a communication status between the first UE and the base station is one of an asymmetric communication and a symmetric communication. Specifically, if the first UE can listen to messages of the base station but cannot transmit messages to the base station, then the communication therebetween is in the asymmetric communication status; and on the other hand, if the first US can listen to messages of the base station and also can transmit messages to the base station, then the communication therebetween is in the symmetric communication status.

Next, step S702 is executed to enable the first UE to listen to the base station according to the pre-authorized setting and based on the communication status. It shall be particularly appreciated that, if the communication between the first UE and the base station is in the asymmetric communication status, the first UE still can use the pre-authorized setting to obtain the related authorized setting of the group communication, and directly listen to group messages broadcasted by the base station according to the related authorized setting of the group communication.

On the other hand, even in case of the symmetric communication status between the first UE and the base station, the first UE still can use the pre-authorized setting to listen to the group message broadcasted by the base station. Thus, the group message can be obtained quickly without the need of uploading data.

Next, step S703 is executed to enable the base station to broadcast the communication group list. Step S704 is executed to enable the first UE to receive the communication group list. Finally, step S705 is executed to enable the first UE to select a communication group from the communication group list according to the pre-authorized setting.

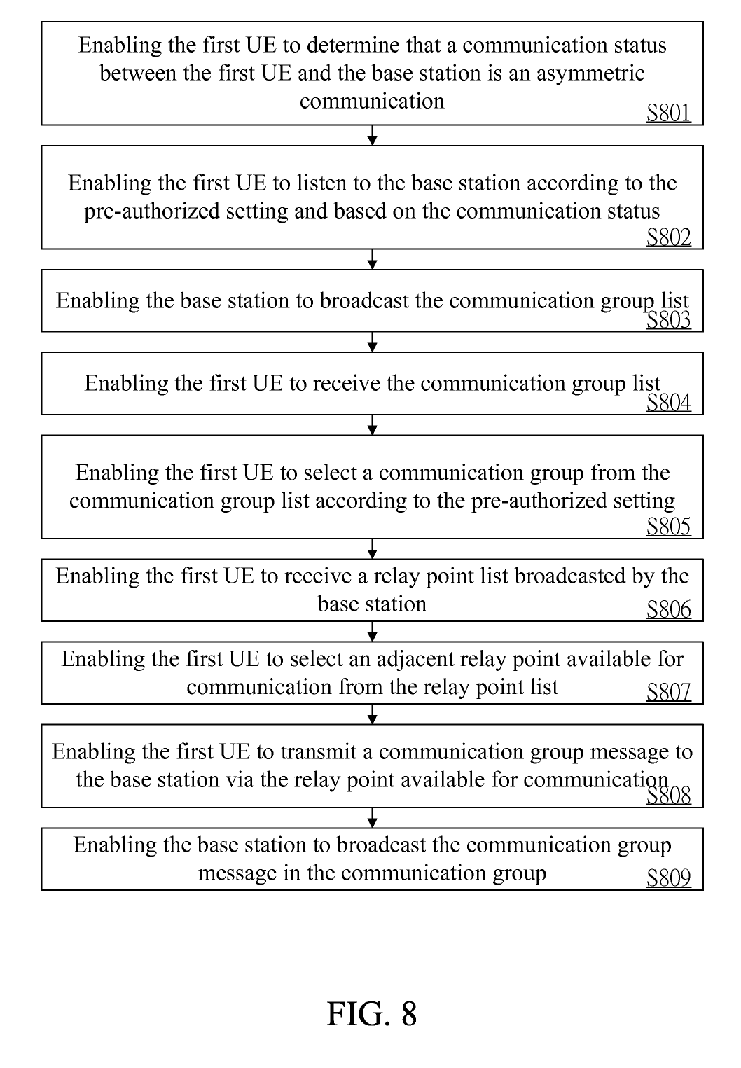

An eighth embodiment of the present invention is a group communication method, a flowchart diagram of which is shown in FIG. 8. The method of the eighth embodiment is for use in an LTE network system (e.g., the LTE network system of the previous embodiments). The LTE network system comprises a base station and a first UE. The base station stores a communication group list, and the first UE stores a pre-authorized setting. Detailed steps of the eighth embodiment are described as follows.

Firstly, step S801 is executed to enable the first UE to determine that a communication status between the first UE and the base station is an asymmetric communication. In other words, the first UE can only listen to messages of the base station but cannot transmit messages to the base station. Step S802 is executed to enable the first UE to listen to the base station according to the pre-authorized setting and based on the communication status. Likewise, the first UE can also use the pre-authorized setting to obtain the related authorized setting of the group communication, and directly listen to the group message broadcasted by the base station according to the related authorized setting of the group communication.

Next, step S803 is executed to enable the base station to broadcast the communication group list. Step S804 is executed to enable the first UE to receive the communication group list. Step S805 is executed to enable the first UE to select a communication group from the communication group list according to the pre-authorized setting. Then, when the first UE is to transmit a message to the base station, it needs the assistance of a relay station.

Step S806 is executed to enable the first UE to receive a relay point list broadcasted by the base station. The relay point list records a list of nodes that can be used to relay messages. Step S807 is executed to enable the first UE to select an adjacent relay point available for communication from the relay point list.

Afterwards, step S808 is executed to enable the first UE to transmit a communication group message to the base station via the relay point available for communication. Finally, step S809 is executed to enable the base station to broadcast the communication group message in the communication group. In this way, even if the communication between the first UE and the base station is in the asymmetric communication status, the first UE still can accomplish the group message broadcasting with the assistance of the relay node.

It shall be particularly appreciated that, in further consideration of the security, the pre-authorized setting of the eighth embodiment may further comprise a key, in which case the communication group list and the relay point list received in the step S804 and the step S806 are encrypted lists, and the first UE can use the key for decryption. On the other hand, the communication group message may also be encrypted first by the first UE through the use of the key before being transmitted in the step S808.

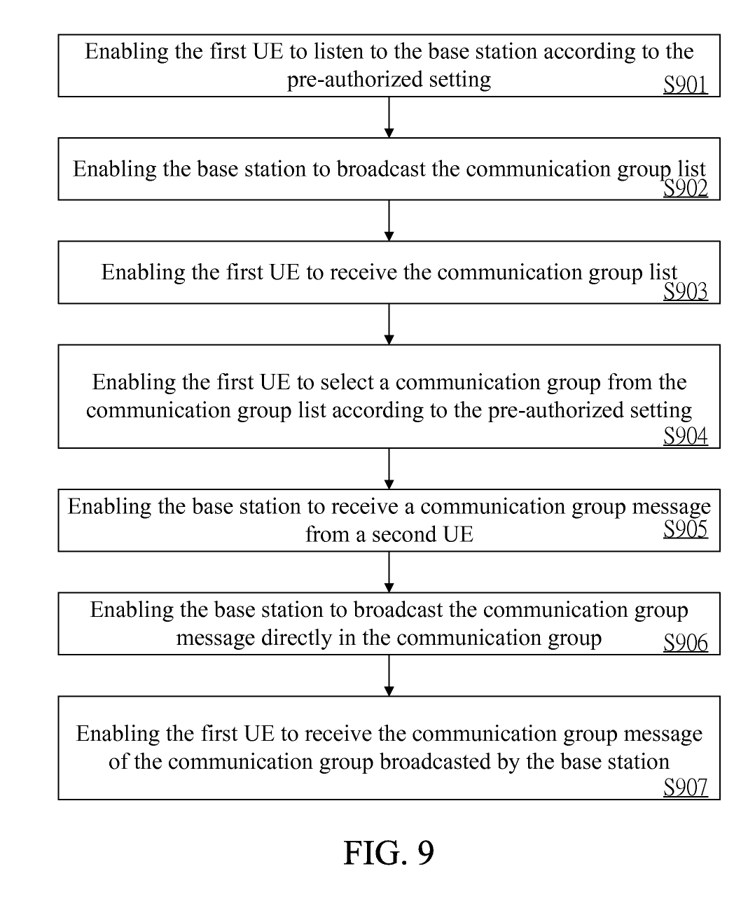

A ninth embodiment of the present invention is a group communication method, a flowchart diagram of which is shown in FIG. 9. The method of the ninth embodiment is for use in an LTE network system (e.g., the LTE network system of the previous embodiments). The LTE network system comprises a base station and a first UE. The base station stores a communication group list, and the first UE stores a pre-authorized setting. Detailed steps of the ninth embodiment are described as follows.

Firstly, because the pre-authorized setting comprises legally authorized information that permits the first UE to join in a communication group of the corresponding LTE network system, step S901 is executed to enable the first UE to listen to the base station according to the pre-authorized setting. Step S902 is executed to enable the base station to broadcast the communication group list.

Then, step S903 is executed to enable the first UE to receive the communication group list. Finally, because the pre-authorized setting may further comprise information indicating the group in which the first UE is to join, step S904 is executed to enable the first UE to select a communication group from the communication group list according to the pre-authorized setting. Thereby, the first UE can use the pre-authorized setting to listen to the group message broadcasted by the base station no matter in a symmetric communication status or in an asymmetric communication status.

Then, step S905 is executed to enable the base station to receive a communication group message from a second UE. The second UE belongs to the communication group. Step S906 is executed to enable the base station to broadcast the communication group message directly in the communication group. Finally, step S907 is executed to enable the first UE to receive the communication group message of the communication group broadcasted by the base station.

Likewise, in further consideration of the security, the pre-authorized setting of the ninth embodiment may further comprise a key, in which case the communication group list and the communication group message received in the step S903 and the step S907 are encrypted information, and the first UE may use the key for decryption.

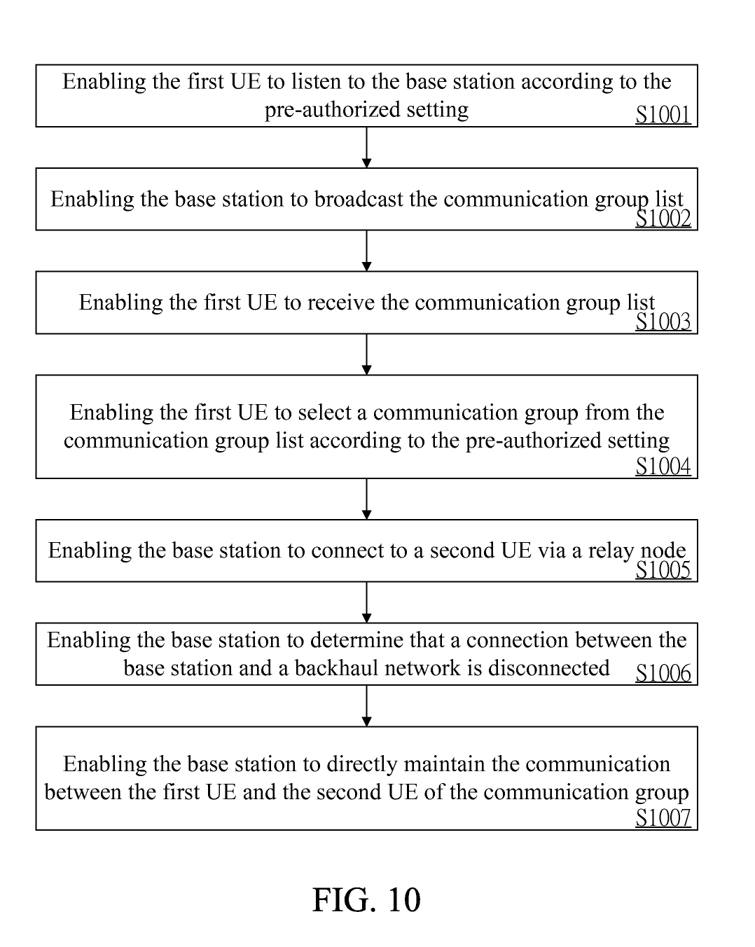

A tenth embodiment of the present invention is a group communication method, a flowchart diagram of which is shown in FIG. 10. The method of the tenth embodiment is for use in an LTE network system (e.g., the LTE network system of the previous embodiments). The LTE network system comprises a base station and a first UE. The base station stores a communication group list, and the first UE stores a pre-authorized setting. Detailed steps of the tenth embodiment are described as follows.

Firstly, because the pre-authorized setting comprises legally authorized information that permits the first UE to join in a communication group of the corresponding LTE network system, step S1001 is executed to enable the first UE to listen to the base station according to the pre-authorized setting. Step S1002 is executed to enable the base station to broadcast the communication group list.

Then, step S1003 is executed to enable the first UE to receive the communication group list. Because the pre-authorized setting may further comprise information indicating the group in which the first UE is to join, step S1004 is executed to enable the first UE to select a communication group from the communication group list according to the pre-authorized setting.

Then, step S1005 is executed to enable the base station to connect to a second UE via a relay node. The second UE belongs to the same communication group. Step S1006 is executed to enable the base station to determine that a connection between the base station and a backhaul network is disconnected. Finally, step S1007 is executed to enable the base station to directly maintain the communication between the first UE and the second UE of the communication group.

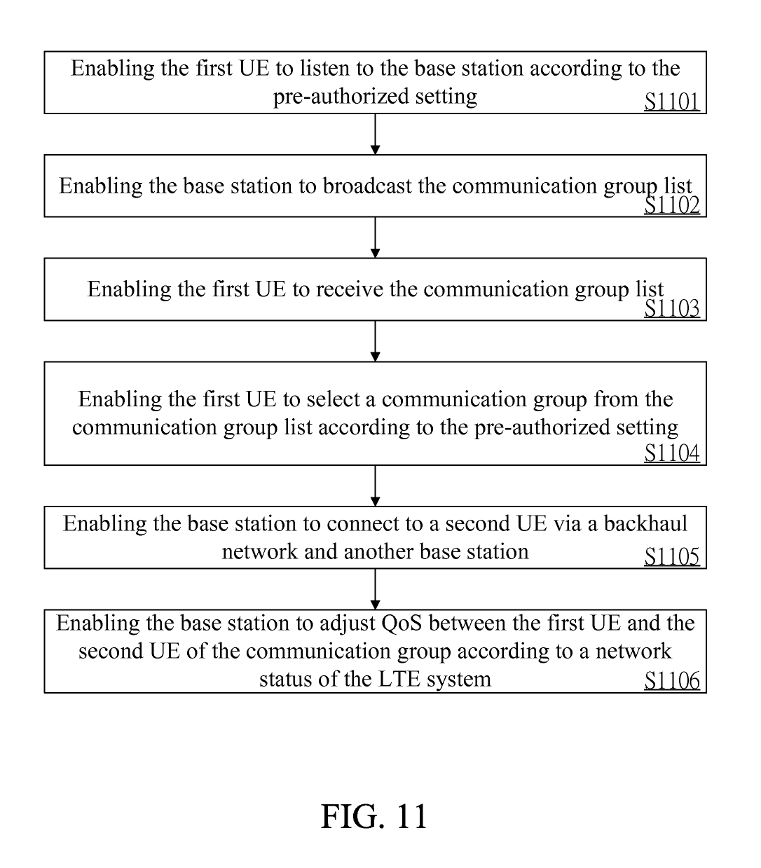

An eleventh embodiment of the present invention is a group communication method, a flowchart diagram of which is shown in FIG. 11. The method of the eleventh embodiment is for use in an LTE network system (e.g., the LTE network system of the previous embodiments). The LTE network system comprises a base station and a first UE. The base station stores a communication group list, and the first UE stores a pre-authorized setting. Detailed steps of the eleventh embodiment are described as follows.

Firstly, because the pre-authorized setting comprises legally authorized information that permits the first UE to join in a communication group of the corresponding LTE network system, step S1101 is executed to enable the first UE to listen to the base station according to the pre-authorized setting. Step S1102 is executed to enable the base station to broadcast the communication group list.

Then, step S1103 is executed to enable the first UE to receive the communication group list. Finally, because the pre-authorized setting may further comprise information indicating the group in which the first UE is to join, step S1104 is executed to enable the first UE to select a communication group from the communication group list according to the pre-authorized setting.

Then, step S1105 is executed to enable the base station to connect to a second UE via a backhaul network and another base station. The second UE belongs to the same communication group. Finally, step S1106 is executed to enable the base station to adjust a Quality of Service (QoS) between the first UE and the second UE of the communication group according to a network status of the LTE system.

According to the above descriptions, the LTE network system and the group communication method thereof according to the present invention mainly allow a UE to directly listen to a corresponding group message broadcasted by a base station through the use of a pre-authorized setting without having to register with the backhaul network. On the other hand, the group message can be processed directly by the base station rather than via the backhaul network. Thereby, the network delay of data transmissions can be effectively solved to increase the utilization efficiency of network resources and group communications can be effectively maintained.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A Long Term Evolution (LTE) network system, comprising:
a base station storing a communication group list; and
a first user equipment (UE);
wherein the first UE is configured to:
listen to the base station according to a pre-authorized setting;
wherein the base station is configured to:
broadcast the communication group list;
and wherein the first UE is further configured to:
receive the communication group list; and
select a communication group from the communication group list according to the pre-authorized setting.

2. The LTE network system of claim 1, wherein the first UE is further configured to:
determine that a communication status between the first UE and the base station is one of an asymmetric communication and a symmetric communication; and
listen to the base station according to the pre-authorized setting and based on the communication status.

3. The LTE network system of claim 2, wherein the communication status is the asymmetric communication, and the first UE is further configured to:
receive a relay point list broadcasted by the base station;
select a relay point available for communication from the relay point list; and
transmit a communication group message to the base station via the relay point available for communication;
and wherein the base station is further configured to:
broadcast the communication group message in the communication group.

4. The LTE network system of claim 3, wherein the pre-authorized setting comprises a key, and the first UE is further configured to:
receive the communication group list and use the key to decrypt the communication group list;
receive the relay point list from the base station and use the key to decrypt the relay point list; and
use the key to encrypt the communication group message, and transmit the communication group message to the base station via the relay point available for communication.

5. The LTE network system of claim 1, wherein the first UE is further configured to:
receive a communication group message of the communication group broadcasted by the base station.

6. The LTE network system of claim 4, wherein the base station is further configured to:
receive the communication group message from a second UE, wherein the second UE belongs to the communication group; and
broadcast the communication group message directly in the communication group;
and wherein the first UE is further configured to:
receive the communication group message of the communication group broadcasted by the base station.

7. The LTE network system of claim 6, wherein the pre-authorized setting comprises a key, and the first UE is further configured to:
receive the communication group list and use the key to decrypt the communication group list; and
receive the communication group message of the communication group broadcasted by the base station, and use the key to decrypt the communication group message.

8. The LTE network system of claim 1, wherein the base station is further configured to:
connect to a second UE via a relay node, wherein the second UE belongs to the communication group;
determine that a connection between the base station and a backhaul network is disconnected; and
directly maintain the communication between the first UE and the second UE of the communication group.

9. The LTE network system of claim 1, wherein the base station is further configured to:
connect to a second UE via a backhaul network and another base station, wherein the second UE belongs to the communication group; and
adjust a Quality of Service (QoS) between the first UE and the second UE of the communication group according to a network status of the LTE system.

10. A base station for use in an LTE network system, the LTE network system further comprises a first UE, and the first UE listening to the base station according to a pre-authorized setting, the base station comprising:
a storage unit, being configured to store a communication group list; and
a transceiving unit, being configured to:
broadcast the communication group list so that the first UE receives the communication group list and selects a communication group from the communication group list according to the pre-authorized setting; and
broadcast a communication group message directly in the communication group.

11. The base station of claim 10, wherein a communication status between the base station and the first UE is an asymmetric communication, the storage unit is further configured to store a relay point list, and the transceiving unit is further configured to broadcast the relay point list so that the first UE selects a relay point available for communication from the relay point list and transmits the communication group message to the base station via the relay point available for communication.

12. The base station of claim 10, wherein the transceiving unit is further configured to:
receive the communication group message from a second UE, wherein the second UE belongs to the communication group; and
broadcast the communication group message directly in the communication group.

13. The base station of claim 10, further comprising a processing unit, wherein the transceiving unit is further configured to connect to a second UE via a relay node, the second UE belongs to the communication group, and the processing unit is configured to determine via the transceiving unit that a connection between the base station and a backhaul network is disconnected and directly maintain communication between the first UE and the second UE of the communication group via the transceiving unit.

14. The base station of claim 10, further comprising a processing unit, wherein the transceiving unit is further configured to connect to a second UE via a backhaul network and another base station, the second UE belongs to the communication group, and the processing unit is configured to adjust a Quality of Service (QoS) between the first UE and the second UE of the communication group according to a network status of the LTE network system and via the transceiving unit.

15. A UE for use in an LTE network system, the LTE network system further comprising a base station, the base station having a communication group list stored therein, the UE comprising:
a transceiving unit, being configured to:
listen to the base station according to a pre-authorized setting; and
receive the communication group list broadcasted by the base station; and
a processing unit, being configured to select a communication group from the communication group list according to the pre-authorized setting.

16. The UE of claim 15, wherein the processing unit is further configured to determine via the transceiving unit that a communication status between the UE and the base station is one of an asymmetric communication and a symmetric communication, and the transceiving unit is further configured to listen to the base station according to the pre-authorized setting and based on the communication status.

17. The UE of claim 16, wherein the communication status is the asymmetric communication, the transceiving unit is further configured to receive a relay point list broadcasted by the base station, the processing unit is further configured to select a relay point available for communication from the relay point list, and the transceiving unit is further configured to transmit a communication group message to the base station via the relay point available for communication so that the base station broadcasts the communication group message in the communication group.

18. The UE of claim 17, wherein the pre-authorized setting comprises a key, and the processing unit is further configured to:
use the key to decrypt the communication group list;
use the key to decrypt the relay point list; and
use the key to encrypt the communication group message.

19. The UE of claim 15, wherein the transceiving unit is further configured to receive a communication group message of the communication group broadcasted by the base station.

20. The UE of claim 19, wherein the pre-authorized setting comprises a key, and the processing unit is further configured to:
use the key to decrypt the communication group list; and
use the key to decrypt the communication group message.
